(19) United States
(12) Patent Application Publication
(10) Pub. No.: US 2007/0235394 A1
(43) Pub. Date: Oct. 11, 2007

(54) MASS THICKENING APPARATUS

(76) Inventor: Joseph W. Dendel, Allegan, MI (US)

Correspondence Address: PRICE HENEVELD COOPER DEWITT & LITTON, LLP, 695 KENMOOR, S.E., P O BOX 2567, GRAND RAPIDS, MI, 49501, US

(21) Appl. No.: 11/554,279

(22) Filed: Oct. 30, 2006

Related U.S. Application Data
(60) Provisional application No. 60/731,030, filed on Oct. 28, 2005.

(51) Int. Cl. C02F 1/38

(52) U.S. Cl. 210/770

(57) ABSTRACT

A mass thickening apparatus comprising a system mass input for accepting a mass having a solid component and a liquid component. The apparatus also includes a pump operably connected to the system mass input for providing a pressure to the mass. The apparatus further includes a thickening assembly adapted to receive the mass therein, with the thickening assembly being configured to selectively remove a percentage of the liquid component from the mass as the mass travels through the thickening assembly by controlling an amount of the liquid component that can be removed from the mass.

### CROSS-REFERENCE TO RELATED APPLICATION

This application claims priority to U.S. Provisional Patent Application No. 60/731,030 filed on Oct. 28, 2005 entitled MASS THICKENING APPARATUS.

### FIELD OF THE INVENTION

The present invention concerns a mass thickening apparatus.

### BACKGROUND OF THE INVENTION

Apparatus for feeding, compressing, liquid extraction, washing and chemical treatment of sludge, slurries or other wet materials are well known. Such equipment finds particular application in the pulp and paper industry, waste water treatment, mineral processing, agriculture, food processing, fisheries, breweries, wineries, chemical processing, oil and tar sands industry, etc.

An improved apparatus is desired for feeding, compressing, liquid extracting, washing and chemical treating of the sludge, slurries or other wet materials.

### SUMMARY OF THE PRESENT INVENTION

An aspect of the present invention is to provide a mass thickening apparatus comprising a system mass input for accepting a mass having a solid component and a liquid component. The apparatus also includes a pump operably connected to the system mass input for providing a pressure to the mass. The apparatus further includes a thickening assembly adapted to receive the mass therein, with the thickening assembly being configured to selectively remove a percentage of the liquid component from the mass as the mass travels through the thickening assembly by controlling an amount of the liquid component that can be removed from the mass.

Another aspect of the present invention is to provide a method of thickening a mass having a solid component and a liquid component. The method comprises providing mass under pressure to a thickening assembly and selectively removing a percentage of the liquid component from the mass with the thickening assembly by controlling an amount of the liquid component that can be removed from the mass. The method further includes outputting the mass with the percentage of the liquid component removed therefrom from the thickening assembly.

Yet another aspect of the present invention is to provide a mass thickening and liquid extraction apparatus comprising a system mass input for accepting a mass having a solid component and a liquid component, a pump operably connected to the system mass input for providing a pressure to the mass, and an assembly adapted to receive the mass therein. The assembly is configured to remove a percentage of the liquid component from the mass as the mass travels through the assembly. The apparatus also includes a valve selectively connectable to a first outlet of the assembly for controlling an amount of the liquid component that can be removed from the mass, and a plate selectively connectable to a second outlet of the assembly for removing the liquid component from the mass.

These and other aspects, objects, and features of the present invention will be understood and appreciated by those skilled in the art upon studying the following specification, claims, and appended drawings.

### BRIEF DESCRIPTION OF DRAWINGS

FIG. 1 is a schematic of a mass thickening apparatus of the present invention.

FIG. 2 is a top view of the mass thickening apparatus of the present invention.

FIG. 3 is a front view of the mass thickening apparatus of the present invention.

FIG. 4 is a side view of the mass thickening apparatus of the present invention.

FIG. 5 is an exploded rear perspective view of a mass thickening assembly and a motor assembly of the apparatus of the present invention.

FIG. 6 is an exploded cross-sectional view of the mass thickening assembly of the present invention.

FIG. 6A is a cross-sectional view of a pair of mass thickening assemblies and a transfer housing of the motor assembly of the apparatus of the present invention.

FIG. 7 is a cross-sectional view of a rotary screen assembly of the mass thickening assembly of the present invention.

FIG. 8 is a rear view of an inner housing shell of the mass thickening assembly and the motor assembly of the mass thickening apparatus of the present invention.

FIG. 9 is side view of the inner housing shell of the mass thickening assembly and the motor assembly of the mass thickening apparatus of the present invention.

FIG. 10 is a first side view of the inner housing shell of the housing of the mass thickening assembly of the present invention.

FIG. 11 is a second side view of the inner housing shell of the housing of the mass thickening assembly of the present invention.

FIG. 12 is a side view of a center seal of the mass thickening assembly of the present invention.

FIG. 13 is a front view of the center seal of the mass thickening assembly of the present invention.

FIG. 14 is a first side view of a drive wheel of the rotary screen assembly of the mass thickening assembly of the present invention.

FIG. 15 is a second side view of a slotted filter screen and the drive wheel of the rotary screen assembly of the mass thickening assembly of the present invention.

FIG. 16 is a cross-sectional view of the slotted filter screen of the present invention.

FIG. 17 is a side view of the motor assembly, the inner housing shell, the slotted filter screen, the drive wheel, the drive shaft and the center seal of the mass thickening assembly of the present invention.

FIG. 18 is a side view of the motor assembly, the inner housing shell, the rotary screen assembly, the drive shaft, and the center seal of the mass thickening assembly of the present invention.

FIG. 19A is a side cross-sectional view of the exit of the first embodiment of the mass thickening assembly of the present invention.

FIG. 19B is a side cross-sectional view of the exit of a first alternative of the first embodiment of the mass thickening assembly of the present invention.

FIG. 20 is a side view of a second embodiment of the center seal of the present invention.

FIG. 21 is a side view of a second embodiment of the mass thickening apparatus of the present invention.

FIG. 22 is a side view of a third embodiment of the mass thickening assembly of the mass thickening apparatus of the present invention.

FIG. 23 is an exploded cross-sectional view of the third embodiment of the mass thickening assembly (except for a center seal of the thickening assembly, which is shown as a front view) of the mass thickening apparatus of the present invention.

FIG. 24 is a cross-sectional view of the third embodiment of the mass thickening assembly of the mass thickening apparatus of the present invention taken along the line XXIV-XXIV of FIG. 22.

FIG. 25 is a partial front view of a fourth embodiment of the mass thickening assembly of the present invention.

FIG. 26 is a partial exploded front view of the fourth embodiment of the mass thickening assembly of the present invention.

FIG. 27 is a side view of a center seal of the fourth embodiment of the mass thickening assembly of the present invention.

FIG. 28 is a side view of an inner housing member of the fourth embodiment of the mass thickening assembly of the present invention.

FIG. 29 is a first side perspective view of a rotary screen assembly of the fourth embodiment of the mass thickening assembly of the present invention.

FIG. 30 is a second side perspective view of a rotary screen assembly of the fourth embodiment of the mass thickening assembly of the present invention.

FIG. 31A is an end view of an exit of the first embodiment of the mass thickening assembly after conversion to a liquid extraction assembly of the present invention in a first position.

FIG. 31B is an end view of the exit of the first embodiment of the mass thickening assembly after conversion to a liquid extraction assembly of the present invention in a second position.

FIG. 31C is an end view of the exit of a second alternative of first embodiment of the mass thickening assembly after conversion to a liquid extraction assembly of the present invention.

FIG. 31D is an end view of the exit of a third alternative of first embodiment of the mass thickening assembly after conversion to a liquid extraction assembly of the present invention.

### DETAILED DESCRIPTION OF PREFERRED EMBODIMENTS

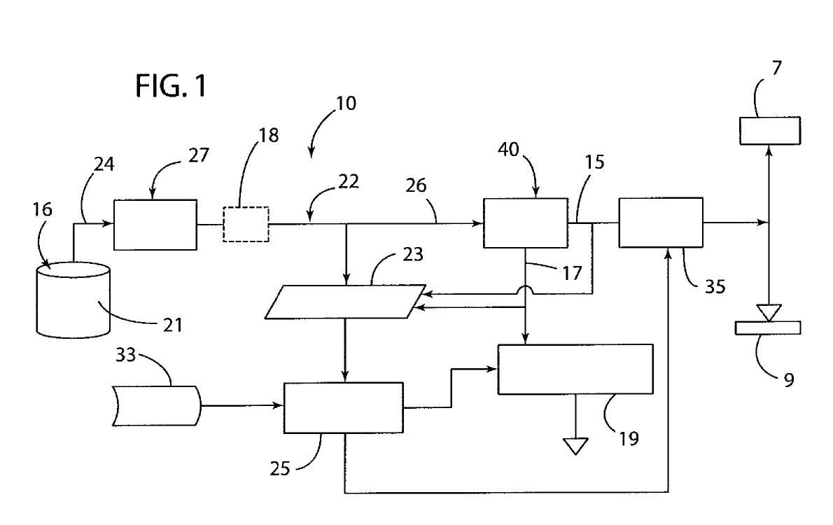

For purposes of description herein, the terms “upper,” “lower,” “right,” “left,” “rear,” “front,” “vertical,” “horizontal,” and derivatives thereof shall relate to the invention as orientated in FIG. 1. However, it is to be understood that the invention may assume various alternative orientations, except where expressly specified to the contrary. It is also to be understood that the specific devices and processes illustrated in the attached drawings, and described in the following specification are simply exemplary embodiments of the inventive concepts defined in the appended claims. Hence, specific dimensions and other physical characteristics relating to the embodiments disclosed herein are not to be considered as limiting, unless the claims expressly state otherwise.

The present invention relates to an apparatus and method for thickening a mass comprising a solid component and a liquid component by removing a percentage of the liquid component from the mass. The mass is preferably a humid mass (e.g., sludges and slurries), as those used or produced in the pulp and paper industry, agricultural, municipal, food and beverage industries, etc. However, it is contemplated that the apparatus of the present invention can be used in any thickening system. The apparatus and method according to the present invention operate on the same basic liquid extraction principle as the system and method described in U.S. Pat. No. 4,534,868, the disclosure of which is hereby incorporated herein by reference, along with the modifications noted below. The present invention is used to remove a percentage of the liquid component from the mass to produce a thickened solid.

The reference number 10 (FIGS. 1-4) generally designates a mass thickening apparatus of the present invention. The apparatus 10 includes a system mass input 16 for accepting a mass having a solid component and a liquid component, a pump 27 operably connected to the system mass input 16 for providing a pressure to the mass, and a mass thickening assembly 40 adapted to receive the mass therein. The mass thickening assembly 40 is configured to selectively remove a percentage of the liquid component from the mass as the mass travels through the mass thickening assembly 40 by controlling an amount of the liquid component that can be removed from the mass.

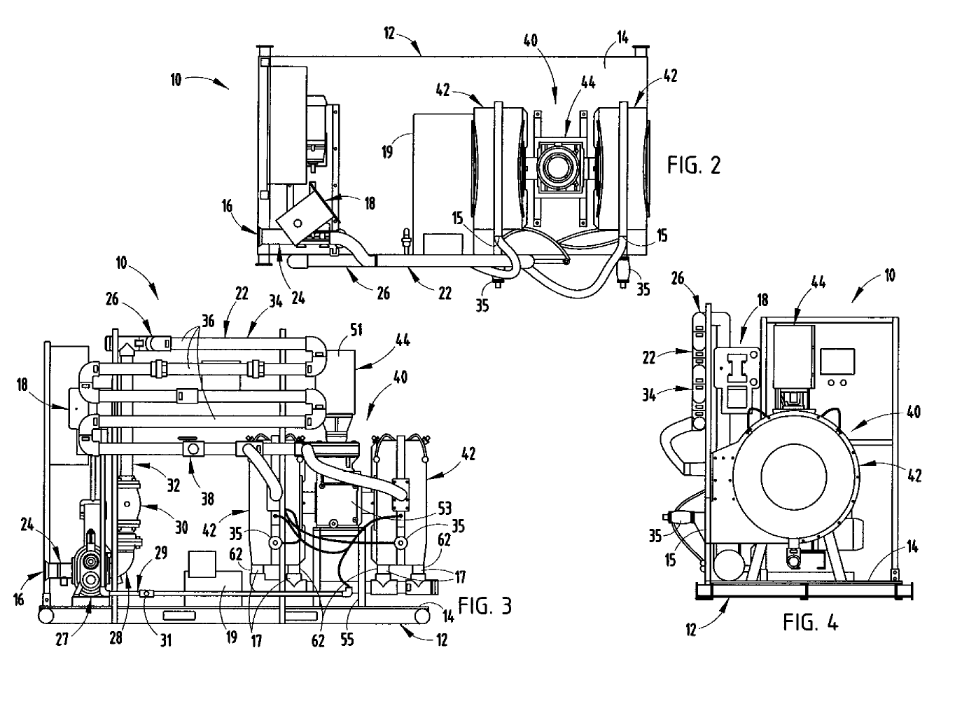

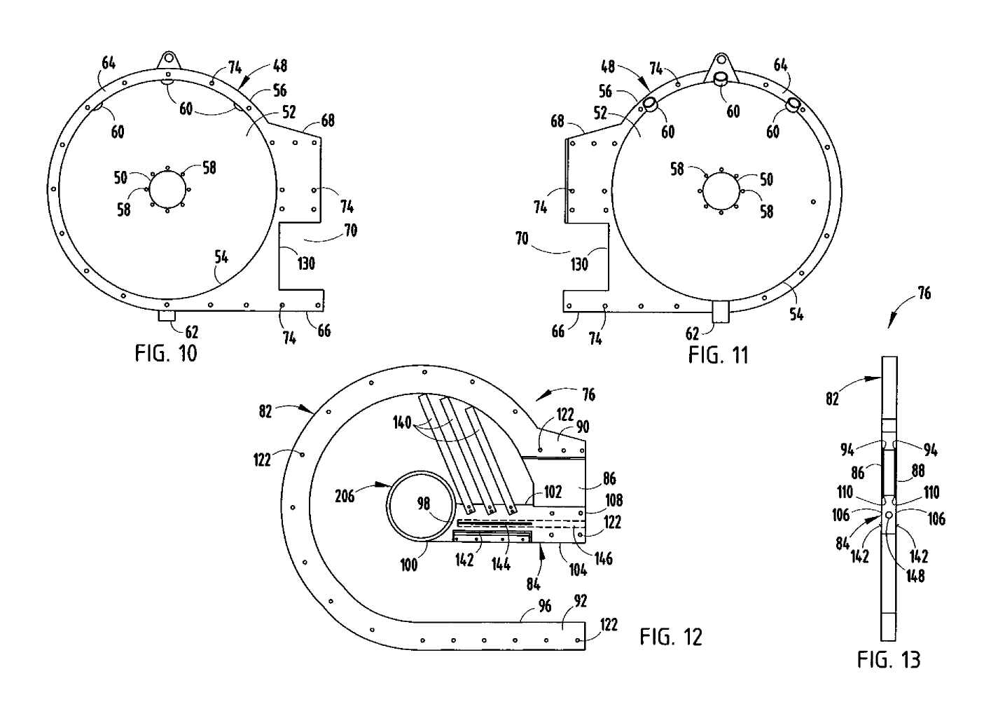

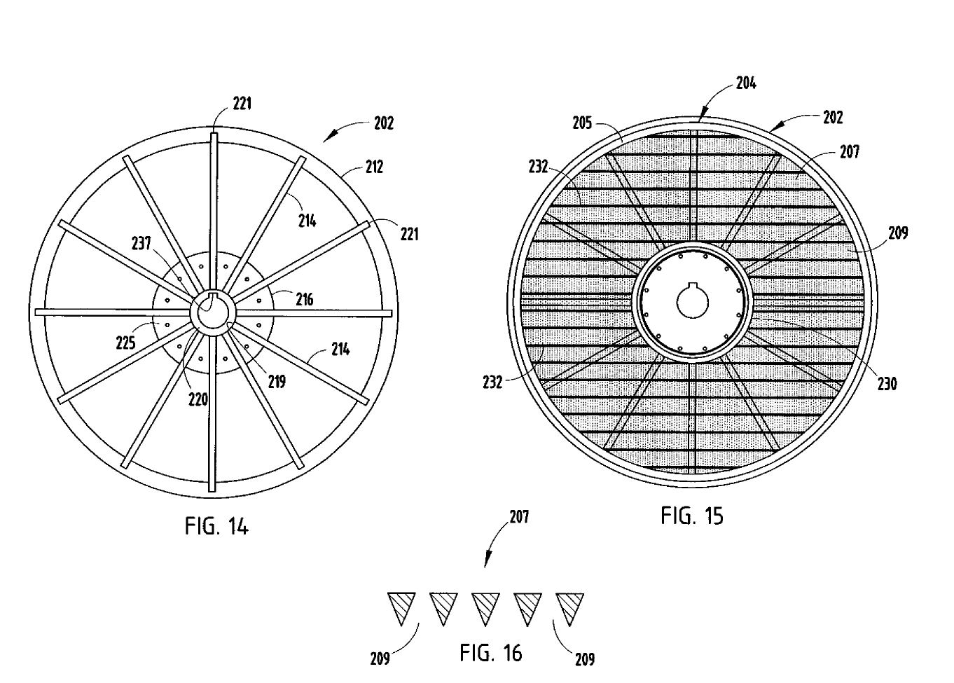

The illustrated mass thickening apparatus 10 comprises a platform 12 having an upper surface 14, the system mass input 16, an optional polymer feeding and blending system 18 on the upper surface 14, the mass thickening assembly 40 on the upper surface 14, and piping 22 having a first section 24 between the system mass input 16 and the optional polymer feeding and blending system 18, and a second section 26 between the polymer feeding and blending system 18 and the mass thickening assembly 40. The apparatus 10 is configured to have mass inputted into the system mass input 16, transport the mass to the polymer feeding and blending system 18 (if present) through the first section 24 of the piping 22, optionally inject polymer into the mass in the polymer feeding and blending system 18, and transport the mass from the polymer feeding and blending system 18 to the mass thickening assembly 40. Pressure from mass forced into the mass thickening assembly 40 along with pressure restricting the liquid portion from leaving the mass and/or the pressure restricting the mass from exiting the mass thickening assembly 40 can force liquid in the mass to exit the mass. In the illustrated embodiment, the mass thickening assembly 40 comprises a pair of thickening housings 42 (see FIGS. 2-18). However, it is contemplated that the mass thickening assembly 40 of the present invention could use any number (including only one) of the thickening housings 42 as described in more detail below.

In the illustrated embodiment, each thickening housing 42 of the mass thickening assembly 40 preferably includes a first outlet 15 for the mass with the percentage of the liquid component removed therefrom and at least one second outlet 17 for the percentage of the liquid component. The first outlet 15 includes a first valve 35 for controlling or regulating the removal of the mass with the percentage of the liquid component removed therefrom. Therefore, the first valve 35 can be used to control the pressure within the thickening housing 42. Furthermore, the second outlet 17 preferably includes a second valve 19 connected thereto for limiting the output of the liquid component from the second outlet 17. By controlling the output of the liquid component with the second valve 19 and/or the mass with the percentage of the liquid component removed therefrom with the first valve 35, the mass thickening assembly 40 is used to increase the percentage of the solid component in the mass (by removing a selected amount of the liquid component from the mass).

In the illustrated embodiment, the apparatus 10 can either include a source of mass (as shown schematically in FIG. 1) or be configured to be connected to a source of mass (as illustrated in FIGS. 2-4). The mass is preferably a humid mass (e.g., sludges and slurries). As stated above, the mass can be that used or produced in the pulp and paper industry, agricultural industries, food and beverages industries, etc. The apparatus 10 of the present invention removes at least a portion of the liquid in the mass. In the illustrated embodiment, the apparatus 10 is portable and can be directly brought to the pulp and paper industry, agricultural industry, food and beverages industries, etc. for use at those locations. The system mass input 16 is configured to be connected to a hose that transports the mass to the apparatus 10 from the source of mass. Preferably, the apparatus 10 is located on the platform 12 that has an upper surface 14 smaller than 72 square feet to provide a compact and easily movable apparatus. However, several of the inventive features disclosed herein can be used in a stationary and fixed apparatus. In a stationary and fixed apparatus, the source of mass can comprise a tank 21 (see FIG. 1) having the mass therein, with the tank 21 communicating with the system mass input 16.

The illustrated apparatus 10 preferably includes the pump 27 for assisting in drawing the mass from the source of mass through the hose or from the tank 21. The mass feed pump 27 also provides pressure to the mass to assist in moving the mass through the piping 22 and into and through the mass thickening assembly 40. Pumps 27 are well known to those skilled in the art. After passing through the mass feed pump 27, the mass is fed into the polymer feeding and blending system 18. The polymer feeding and blending system 18 is configured to be connected to a water supply 29 for mixing water with polymer in the polymer feeding and blending system 18. In the illustrated example, the apparatus 10 includes a fitting 31 for connecting to a water supply for supplying the polymer feeding and blending system 18 with the water. The polymer feeding and blending system 18 includes an injection area 28 connected to the first section 24 and the second section 26 of the piping 22 and defines a transition from the first section 24 to the second section 26. After the water is mixed with the polymer, a combination of the water and polymer is injected into the injection area 28 for mixing with the mass from the first section 24 before the mass is moved to the second section 26 of the piping 22. The polymer feeding and blending system 18 and the polymer used therein are well known to those skilled in the art. The polymer is preferably a conventional known polymer flocculent, such as a polyacrylamide. However, it is contemplated that the apparatus 10 could be used without an added polymer and without the polymer feeding and blending system 18.

In the illustrated example, once the mass is moved to the second section 26 of the piping 22, the mass is thoroughly mixed with the combination of polymer and water in an adjustable mix valve 30 in the second section 26 of the piping 22 if a polymer feeding and blending system is used. The second section 26 of piping 22 preferably includes a first portion 32 extending vertically upwards from the mix valve 30 to a top of the second section 26 of the piping 22. The second section 26 of the piping 22 also includes a second portion 34 comprising a plurality of horizontal rows 36 of pipes, with each row 36 connected at one end to the row 36 above and at another end at the row 36 below. The second portion 34 of the second section 26 of the piping 22 is connected to the mass thickening assembly 40, wherein the mass is fed into the mass thickening assembly 40. In the illustrated embodiment, the second section 26 of the piping 22 includes a mass bypass tube 38 having a selectively opening valve for allowing the mass in the second section 26 of the piping 22 to bypass the mass thickening assembly 40. It is contemplated that the mass taken out of the second section 26 of the piping 22 could be reinserted into the apparatus 10 by placing the mass taken out of the second section 26 into the source of mass or directly or indirectly into the system mass input 16. Likewise, the second section 26 of the piping 22 can include an extraction valve for each mass thickening housing 42 of the mass thickening assembly 40 for selectively allowing the mass in the second section 26 to be fed into one or more of the mass thickening housings 42. FIG. 1 illustrates a schematic representation of the apparatus 10. The apparatus 10 can include at least one conveyor (not shown) for accepting the thickened portion of the mass exiting one or more of the mass thickening assemblies 40 to move the mass to a collecting device (not shown).

In the illustrated example, the mass thickening assembly 40 accepts the mass from the piping 22 and outputs a thickened solid and the at least a portion of the liquid. The mass thickening assembly 40 of the present invention includes a pair of the mass thickening housings 42 connected to a motor assembly 44. In the illustrated example, the apparatus 10 of the present invention comprises a pair of mass thickening housings 42 that share the motor assembly 44. However, it is contemplated that only one mass thickening housing 42 could be used or that each mass thickening housing 42 could have its own motor assembly 44. Furthermore, the apparatus 10 can include any number of mass thickening housings 42.

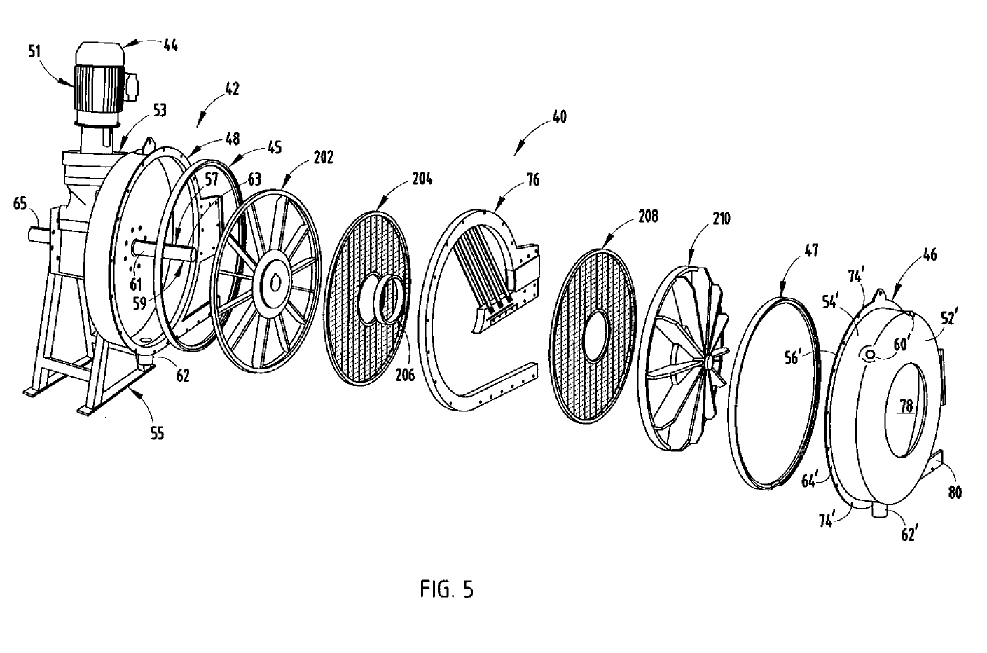

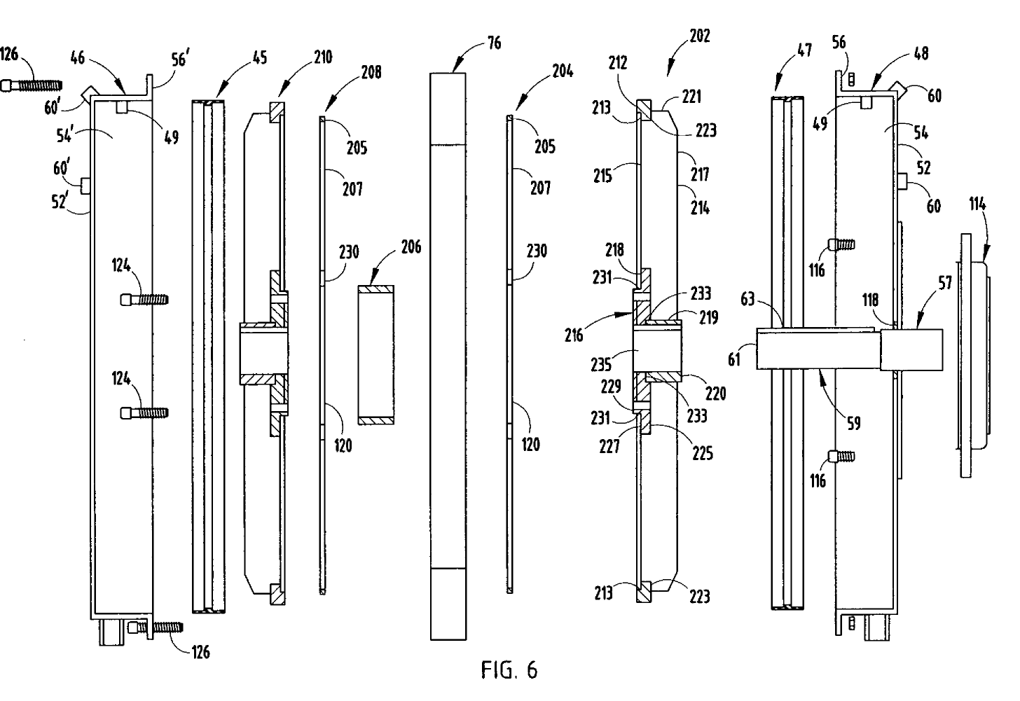

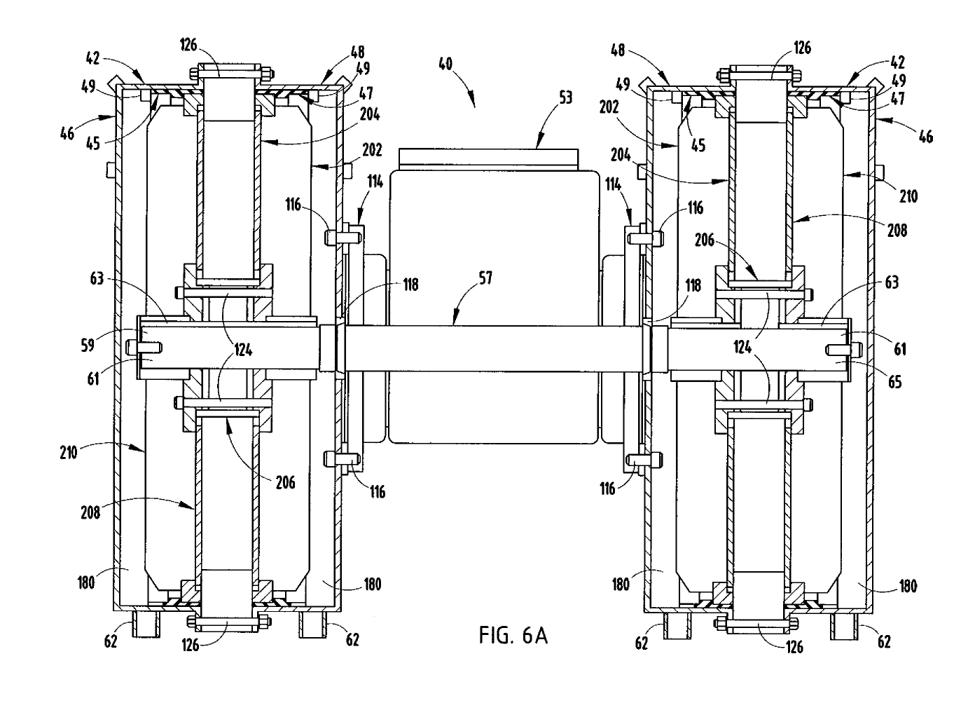

The illustrated motor assembly 44 powers the mass thickening assemblies 40. The motor assembly 44 includes an upright motor 51, a transfer housing 53 and a support 55. The support 55 extends upwardly from the platform 12 between the mass thickening housings 42. The upright motor 51 includes a vertical rotary output shaft (not shown) that extends into the transfer housing 53. The transfer housing 53 transmits the rotary motion of the vertical rotary output shaft of the upright motor 51 to a horizontal motor assembly output shaft 57 (see FIG. 6A) in a manner well known to those skilled in the art (e.g., a worm gear or any other means). The motor assembly output shaft 57 includes a first end 65 that extends into a first one of the mass thickening housings 42 and a second end 59 that extends into a second one of the mass thickening housings 42. As illustrated in FIGS. 5 and 6A, the first end 65 and the second end 59 of the motor assembly output shaft 57 each include a cylindrical portion 61 and a key flange 63 extending along a longitudinal surface of the cylindrical portion 61. The first end 65 and the second end 59 of the motor assembly output shaft 57 power the mass thickening assemblies 40 as described in more detail below.

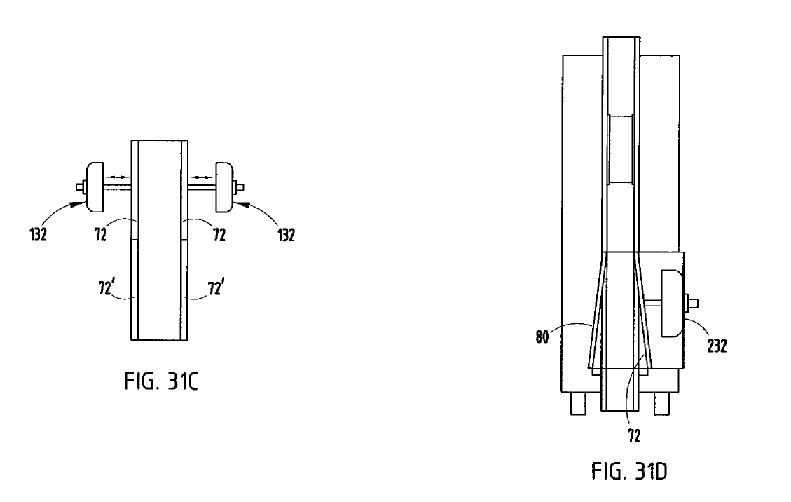

As illustrated in FIGS. 5, 6 and 6A, each mass thickening assembly 40 comprises the housing 42 including an outer housing shell 46 and an inner housing shell 48. The inner housing shell 48 (FIGS. 5, 6 and 8-11) includes a circular base wall 52, a tubular wall 54 extending from the base wall 52 and a peripheral flange 56 extending from the tubular wall 54 opposite the base wall 52. The circular base wall 52 includes a drive shaft opening 50 centrally located therein and a plurality of fastener openings 58 surrounding the drive shaft opening 50. The fastener openings 58 are configured to accept fasteners therein to connect the inner housing shell 48 to the motor assembly 44. The edge between the base wall 52 and the tubular wall 54 includes three sanitary holes 60 for allowing a cleaning fluid to be injected into the inner housing shell 48 when the housing 42 of the mass thickening assembly 40 is constructed to clean the mass thickening assembly 40 as discussed below. Although three sanitary holes 60 are shown, any number of sanitary holes 60 could be employed. The sanitary holes 60 can be plugged during normal use of the mass thickening assembly 40 or opened to allow water or other cleaning fluid to be injected into the mass thickening assembly 40 to clean the mass thickening assembly 40. It is contemplated that the sanitary holes 60 could have a threaded outer surface for connection to a common garden hose. The tubular wall 54 further includes a filtrate drain 62 located at a bottom of the tubular wall 54. The filtrate drain 62 allows the liquid extracted from the mass and any cleaning fluid injected into the housing 42 to exit the mass thickening assembly 40. The peripheral flange 56 of the inner housing shell 48 includes a circular portion 64, a bottom extending lip portion 66 and a nose portion 68. The bottom extending lip portion 66 and the nose portion 68 define an open mouth 70. As explained in more detail below, the open mouth 70 is configured to have a stationary wall placed therein. Alternatively, when the mass thickening assembly 40 is converted into a liquid extraction assembly, the open mouth 70 is configured to have a movable side wall 72 (see FIGS. 31A and 31B) inserted therein. The circular portion 64, the bottom extending lip portion 66 and the nose portion 68 all include a plurality of connection openings 74 for connecting a center seal 76 (described below) and the outer housing shell 46 to the inner housing shell 48. The inner housing shell 48 and the outer housing shell 46 are substantially a mirror image of each other (except that the outer housing shell 46 does not include the drive shaft opening 50, the mouth 70 and other details noted below).

In the illustrated example, the outer housing shell 46 includes a circular base wall 52′, a tubular wall 54′ extending from the base wall 52′ and a peripheral flange 56′ extending from the tubular wall 54′ opposite the base wall 52′. The circular base wall 52′ can include a window 78 centrally located therein for viewing an interior of the housing 42. The edge between the base wall 52′ and the tubular wall 54′ includes three sanitary holes 60′ for allowing a cleaning fluid to be injected into the inner housing shell 48 when the housing 42 is constructed to clean the mass thickening assembly 40 as discussed below. Although three sanitary holes 60′ are shown, any number of sanitary holes 60′ could be employed. The sanitary holes 60′ can be plugged during normal use of the mass thickening assembly 40 or opened to allow water or other cleaning fluid to be injected into the housing 42 to clean the mass thickening assembly 40. The tubular wall 54′ further includes a filtrate drain 62′ located at a bottom of the tubular wall 54′. The filtrate drain 62′ allows the liquid extracted from the mass and any cleaning fluid injected into the housing 42 to exit the mass thickening assembly 40. The peripheral flange 56′ of the inner housing shell 48′ includes a circular portion 64′ and an extension portion 80 extending from the circular portion 64′. The extension portion 80 has a peripheral shape substantially identical to the bottom extending lip portion 66, the nose portion 68 and the open mouth 70 of the inner housing shell 48. The circular portion 64′ and the extension portion 80 include a plurality of connection openings 74′ corresponding to the connection openings 74′ of the inner housing shell 48 for connecting the center seal 76 (described below) and the inner housing shell 48 to the outer housing shell 46.

The illustrated center seal 76 (FIGS. 5, 6, 6A, 12 and 13) is positioned between the inner housing shell 48 and the outer housing shell 46 and defines an upper and lower boundary of the mass traveling through one of the housings 42 of the mass thickening assembly 40. The center seal 76 also defines the inlet and the outlet for the mass through the housing 42. The center seal 76 includes an outer C-shaped portion 82, a scraper portion 84, a first inlet plate 86 and a second inlet plate 88. The outer C-shaped portion 82 includes an inlet extension 90 and a first outlet extension 92. The inlet extension 90 includes a pair of grooves 94 configured to accept a top edge of the first inlet plate 86 and the second inlet plate 88. The outlet extension 92 of the outer C-shaped portion 82 includes an angled top surface 96. The scraper portion 84 is located between the outlet extension 92 and the inlet extension 90 of the outer C-shaped portion 82. The scraper portion 84 includes an inner annular face 98 having a scraping tip 100, a top face 102, a bottom face 104, a pair of side faces 106, and an end face 108 opposite to the inner annular face 98. A pair of upper grooves 110 in the pair of side faces 106 are configured to accept a bottom edge of the first inlet plate 86 and the second inlet plate 88. The bottom face 104 of the scraper portion 84 and the angled top surface 96 of the outlet extension 92 of the outer C-shaped portion 82 define a top and bottom surface for the outlet of the solid portion of the mass that tapers outwardly. The outer C-shaped portion 82, the scraper portion 84, the first inlet plate 86 and the second inlet plate 88 each include connection openings 122 for connecting the center seal 76 to the inner housing shell 48 and the outer housing shell 46 as described below.

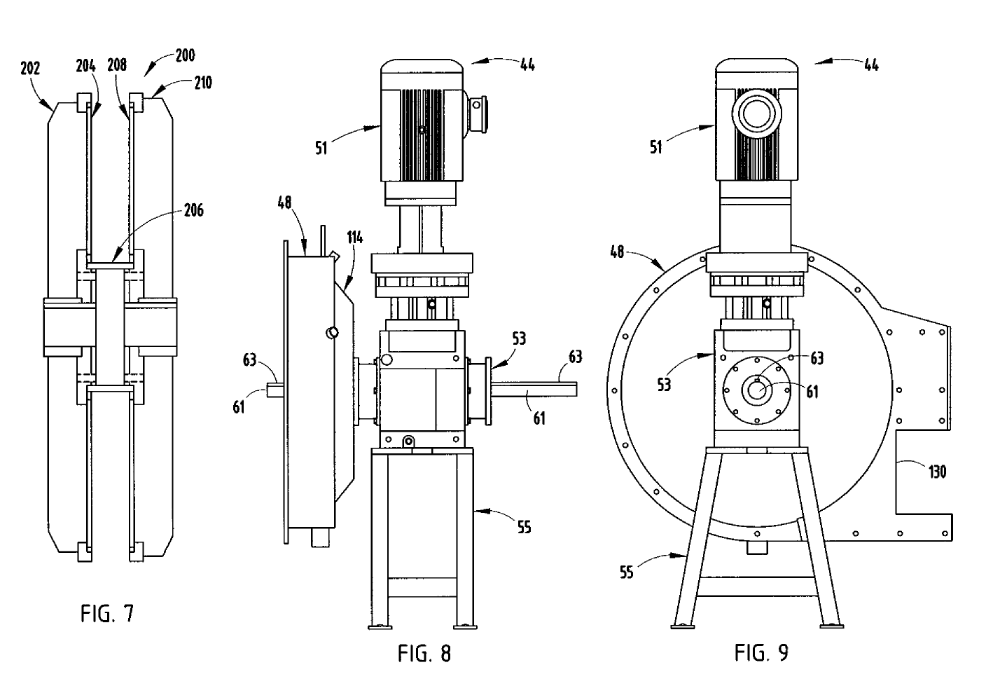

In the illustrated example, a rotary screen assembly 200 (FIG. 7) surrounds the center seal 76 and assists in removing a portion of the liquid from the mass. The rotary screen assembly 200 includes a first side drive wheel 202, a first side slotted filter screen 204, a center hub/spacer 206, a second side slotted filter screen 208 and a second side drive wheel 210. The first side drive wheel 202 and the second side drive wheel 210 are preferably identical, but in an opposite orientation. Likewise, the first side slotted filter screen 204 and the second side slotted filter screen 208 are preferably identical, but in an opposite orientation.

The illustrated first side drive wheel 202 and the second side drive wheel 210 (FIGS. 5-7, 14 and 15) each include an outer rim 212, a plurality of spokes 214 and an inner rim assembly 216. The outer rim 212 is substantially circular and includes an inner periphery notch 213. The plurality of spokes 214 each includes an inner edge 215, an outer edge 217, and inside end 219 and an outside end 221. An outer rim notch 223 is located at the intersection of the inner edge 215 and the outside end 221. The outer rim 212 is located in the outer rim notch 223. The spokes 214 also include an inner rim notch 225 located at the intersection of the inner edge 215 and the inside end 219. The inner rim assembly 216 comprises an inner annular plate 218 and a tubular drive shaft member 220. The inner annular plate 218 is located in the inner rim notch 225 of the spokes 214. The inner annular plate 218 includes a base portion 227 and a circular extension member 229 defining a center spacer/hub support notch 231 located outside of the circular extension member 229 and on a surface of the base portion 227 from which the circular extension member 229 extends. The base portion 227 of the inner annular plate 218 also includes a rear notch 233 having the tubular drive shaft member 220 therein. The inner annular plate 218 and the tubular drive shaft member 220 define a drive shaft opening 235 for accepting the first end 65 or the second end 59 of the motor assembly output shaft 57 therein. The key flange 63 of the first end 65 or the second end 59 of the motor assembly output shaft 57 is accepted into a drive shaft notch 237 of the drive shaft opening 235 to ensure that the tubular drive shaft member 220 and the inner annular plate 218 rotate with the motor assembly output shaft 57.

In the illustrated example, the first side slotted filter screen 204 and the second side slotted filter screen 208 (FIGS. 5-6A, 15 and 16) each include an outer rim 205, a face 207 having a plurality of slots 209 and an inner hub 230. It is contemplated that the slotted filter screens could be made by connecting a plurality of wires to the outer rim 205 and the inner hub 230, thereby defining the slots 209. Alternatively, it is contemplated that the slotted filter screens 204 and 208 could be made by etching (for example, using water or another liquid) slots into an annular plate, thereby forming the outer rim 205, the face 207 having the plurality of slots 209 and the inner hub 230. The slotted filter screens 204 and 208 can also include a plurality of support bars 232 extending between the outer rim 205 and the inner hub 230 for supporting a rear side of the face 207 having the plurality of slots 209 therein. The slots 209 allow for a high filtration area over the slotted filter screens 204 and 208 compared to a perforated plate of the prior art, thereby providing a higher solid capture rate and easier cleaning. The spokes 214 of the first side drive wheel 202 and the second side drive wheel 210 abut against the support bars 232 of the slotted filter screens 204 and 208. It is contemplated that the slotted filter screens 204 and 208 could have any diameter, including 24 and 36 inches. The slots 209 preferably extend from a first point on the circumference of the slotted filter screens 204, 208 to a second point on the circumference of the slotted filter screens 204, 208 (with a possible interruption if the slots cross the center of the slotted filter screens 204, 208). As illustrated in FIG. 16, the slots 209 preferably have a triangular shape, with the larger end of the slots 209 abutting against the mass as the mass moves through the housing 42.

The illustrated mass thickening assembly 40 is assembled by connecting the housings 42 to the motor assembly 44. In the discussion below, only the connection of one housing 42 to the motor assembly 44 will be described. However, any remaining housings 42 can be connected to the motor assembly 44 in a similar manner. In connecting the housing 42 to the motor assembly 44, the first step is to connect the inner housing shell 48 to the motor assembly 44 as illustrated in FIGS. 8 and 9. The inner housing shell 48 is connected to the motor assembly 44 by first placing an annular cap 114 (see FIGS. 6 and 6A) over the second end 59 of the motor assembly output shaft 57 and connecting the annular cap 114 to the transfer housing 53 of the motor assembly 44. The second end 59 of the motor assembly output shaft 57 is then inserted through the drive shaft opening 50 of the inner housing shell 48. The inner housing shell 48 is then connected to the motor assembly 44 by inserting fasteners 116 through the fastener openings 58 in the base wall 52 of the inner housing shell 48 and into the annular cap 114 (which is connected to the transfer housing 53). As illustrated in FIGS. 6 and 6A, a seal 118 is located between the motor assembly output shaft 57 and the drive shaft opening 50 of the inner housing shell 48.

After the inner housing shell 48 has been connected to the motor assembly 44, the first side drive wheel 202 of the rotary screen assembly 200 is slid onto the second end 59 of the motor assembly output shaft 57. The first side drive wheel 202 is slid onto the motor assembly output shaft 57 by inserting the second end 59 of the motor assembly output shaft 57 into the drive shaft opening 235 of the inner annular plate 218 and the tubular drive shaft member 220 of the first side drive wheel 202, with the key flange 63 of the second end 59 of the motor assembly output shaft 57 being inserted into the drive shaft notch 237 of the drive shaft opening 235 as discussed above. Thereafter, the center hub/spacer 206 is placed around circular extension member 229 of the inner rim assembly 216 of the first side drive wheel 202. The first side slotted filter screen 204 is then placed over the center hub/spacer 206 by inserting the center hub/spacer 206 within an opening 120 defined by the inner hub 230 of the first side slotted filter screen 204. Once the first side slotted filter screen 204 is fully slid over the center hub/spacer 206, the first side slotted filter screen 204 will abut against the inner edges 215 of the spokes 214 of the first side drive wheel 202 and be located between the inner periphery notch 213 of the first side drive wheel 202 and the center hub/spacer 206. When the first side drive wheel 202 and the first side slotted filter screen 204 are fully connected to the motor assembly output shaft 57 as described directly above, the first side drive wheel 202 and the first side slotted filter screen 204 will be located within the inner housing shell 48.

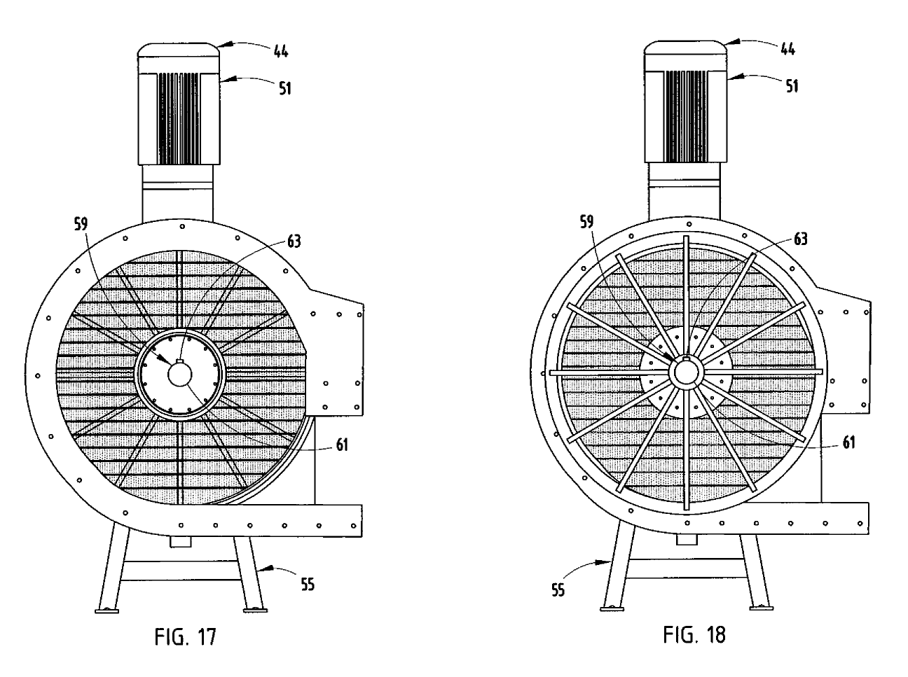

After the first side drive wheel 202, the first side slotted filter screen 204 and the center hub/spacer 206 are assembled as described directly above, the center seal 76 is positioned against the peripheral flange 56 of the inner housing shell 48 as shown in FIG. 17. The center seal 76 is positioned such that the connection openings 122 of the center seal 76 are aligned with the connection openings 74 of the inner housing shell 48. Furthermore, the outside surface of the center hub/spacer 206 will abut the inner annular face 98 of the scraper portion 84 of the center seal 76 as illustrated in FIG. 12. Thereafter, the second side slotted filter screen 208 is slid onto the center hub/spacer 206 by inserting the center hub/spacer 206 within an opening 120 defined by the inner hub 230 of the second side slotted filter screen 208. The second side filter screen 208 is then connected to the housing 42 by inserting the second end 59 of the motor assembly output shaft 57 through the drive shaft opening 235 of the inner annular plate 218 and the tubular drive shaft member 220 of the second side drive wheel 210, with the key flange 63 of the second end 59 of the motor assembly output shaft 57 being inserted into the drive shaft notch 237 of the drive shaft opening 235 as discussed above. Furthermore, the circular extension member 229 is inserted into the center hub/spacer 206 and the second side slotted filter screen 208 will abut against the inner edges 215 of the spokes 214 of the second side drive wheel 210 and be located between the inner periphery notch 213 of the second side drive wheel 210 and the center hub/spacer 206. Additionally, a plurality of fasteners 124 are inserted through openings in the inner rim assemblies 216 of the first side drive wheel 202 and the second side drive wheel 210 as illustrated in FIGS. 6 and 6A to assemble the rotary screen assembly 200. The assembly of the housing 42 up to this point is illustrated in FIG. 18. Finally, the outer housing shell 46 is abutted against the center seal 76 and the connection openings 74′ of the outer housing shell 46 are aligned with the connection openings 122 in the center seal 76 and the connection openings 74 in the inner housing shell 48, and fasteners 126 are inserted through the connection openings 74, 74′ and 122 to connect the inner housing shell 48, the center seal 76 and the outer housing shell 46. While a particular assembly procedure has been outlined above, it is contemplated that the mass thickening assembly 40 could be assembled in any manner. For example, the rotary screen assembly 200 can be assembled as a unitary piece before being connected to the housing 42 of the mass thickening assembly 40. Furthermore, it is contemplated that the mass thickening assembly 40 could include a T-shaped seal 45 located between the outer housing shell 46 and the second side drive wheel 210 and between the inner housing shell 48 and the first side drive wheel 202 as illustrated in FIGS. 5-6A, with the T-shaped seals 45 being wedged between the center seal 76, the tubular wall 54, the first side drive wheel 202 and a stop 49 extending from the tubular wall 54 on one side and between the center seal 76, the tubular wall 54′, the second side drive wheel 210 and a stop 49 extending from the tubular wall 54 on the other side.

Once the housing 42 is assembled as described above, the mass will have a path through the housing 42 defined by the center seal 76, the first side slotted filter screen 204, the second side slotted filter screen 208, the center spacer/hub 206, the extension 80 of the outer housing shell 46 and the side wall 72. Therefore, the mass enters into the housing 42 through an inlet defined by the inlet extension 90, the first inlet plate 86, the second inlet plate 88 and the top face 102 of the scraper portion 84 of the center seal 76. The mass then moves towards a rear of the center seal 76 and around the center hub/spacer 206 in a path defined by the inner surface of the outer C-shaped portion 82 of the center seal 76, first side slotted filter screen 204, the second side slotted filter screen 208 and the center spacer/hub 206. Finally, the mass exits the housing 42 through an assembly exit (i.e., the first outlet 15) defined by the bottom face 104 of the scraper portion 84 of the center seal 76, the angled top surface 96 of the outlet extension 92, the extension 80 of the outer housing shell 46 and the side wall 72.

In use, the mass enters the housing 42 through the inlet and is forced around the center hub/spacer 206. While the center seal 76 and the housing 42 are fixed in position, the rotary screen assembly 200 will rotate with the motor assembly output shaft 57 as described above. The pressure of the mass in the piping 22 will force the mass through the mass thickening assembly 40 towards the outlet of the housing 42 of the mass thickening assembly 40. However, as the mass is moving through mass thickening assembly 40, the slotted filter screens 204, 208 on either side of the mass will remove a portion of the liquid from the mass as described in U.S. Pat. No. 4,534,868, with the limitation caused by the first and/or second valves as described below. As the slotted filter screens 204, 208 remove a portion of the liquid from the mass, the liquid falls down through a pair of areas 180 (see FIG. 6A) between the rotary screen assembly 200 and each of the inner housing shell 48 and the outer housing shell 46. The liquid then exits the housing 42 through the filtrate drains 62. Therefore, the liquid portion will flow through the slotted filter screens 204, 208 and down through the filtrate drains 62, 62′ of the outer housing shell 46 and the inner housing shell 48, respectively. As the mass moves in the circular path within the housing 42, the scraping tip 100 of the scraping portion 84 of the center seal 76 will scrape the mass off of the center hub/spacer 206 and move the mass to the outlet of the housing 42. As the mass moves towards the first outlet 15 of the housing 42, the mass will comprise the solid portion of the mass with the percentage of liquid removed. Since the mass discharge zone is tapered outward as described above, rather than straight, the mass can be better controlled and bridging and/or binding of the mass will be reduced.

As described above, the second valve 19 controls the pressure of the percentage of the liquid component in the second outlet 17. Therefore, the second valve 19 will maintain liquid in the areas 180 at a certain pressure. By controlling the pressure of the liquid in the area 180 (via the pressure in the second outlet 17), the second valve 19 can control the amount of liquid being removed from the mass. For example, if the pressure of the mass in second piping section 26 is equal to the pressure of the liquid in the areas 180, no liquid will be removed from the mass as a result of the second valve 19 as the mass passes through the thickening assembly 40. However, once the second valve 19 opens, the second valve 19 will allow the pressure of the liquid in the second outlet 17, and thereby the areas 180, to lessen. The second valve 19 is preferably continuously adjustable to thereby allow the pressure in the second outlet 17, and thereby the areas 180, to be continuously adjusted. The second valve 19 can be a pinch valve, such as that sold under the name Type A Pinch Valve by Red Valve Company, Inc. of Pittsburgh, Pa. The second valve 19 can comprise a plurality of valves that are each directly connected to each drain 62 such that the pressure in each area 180 can be controlled. However, the second valve 19 could be only coupled to each housing 42 to control the pressure in the areas 180 in a single housing 42 or coupled to each mass thickening assembly 40 for controlling the pressure of the areas 180 in the entire assembly 40. It is further contemplated that any valve or any system for raising the pressure of the liquid in the areas 180 could be used. The second valve 19 can therefore be adjusted to have the pressure of the liquid in the areas 180 be maintained at any level, with a greater difference between the pressure of the liquid in the areas 180 and the pressure of the mass in the thickening assembly 40 allowing a greater percentage of liquid to be removed from the mass.

Furthermore, as described above, the first valve 35 controls the pressure of the mass exiting the housing 42, thereby controlling the percentage of the liquid component removed from the mass. Therefore, the first valve 35 will maintain the mass exiting the first outlet 15 at a certain pressure. By controlling the pressure of the mass in the first outlet 15, the first valve 35 can control the amount of liquid being removed from the mass. For example, if the pressure of the mass in second piping section 26 is equal to the pressure of the mass in the first outlet 15, no liquid will be removed from the mass as a result of the first valve 35 as the mass passes through the thickening assembly 40. However, once the first valve 35 closes, the first valve 35 will force the pressure of the mass in the thickening assembly 40 to increase, thereby raising the pressure of the mass in the thickening assembly 40 above the liquid in the areas 180. The first valve 35 is preferably continuously adjustable to thereby allow the pressure in the first outlet 15 to be continuously adjusted. The first valve 15 is preferably a cone valve. However, it is contemplated that any valve or any system for raising the pressure of the mass in the housing 42 could be used. The first valve 15 can therefore be adjusted to have the pressure of the mass in the thickening assembly 40 raise above the pressure of the liquid in the areas 180, with a greater difference between the pressure of the mass in the thickening assembly 40 and the liquid in the areas 180 allowing a greater percentage of liquid to be removed from the mass. Therefore, the thickness of the mass exiting the thickening assembly 40 can be controlled.

As illustrated in FIG. 1, the apparatus 10 preferably includes at least one pressure sensor 23 for sensing the pressure of the mass in the second piping section 26, for sensing the pressure in the first outlet 15 and/or for sensing the pressure in the second outlet 17. The at least one pressure sensor 23 measures the pressure differential between the pressure of the mass in the second piping section 26 and the pressure in the second outlet 17 and/or the pressure differential between the pressure of the mass in the second piping section 26 and the pressure in the first outlet 15. The at least one pressure sensor 23 then sends this information to a proportional relay 25. The proportional relay 25 receives the information from the at least one pressure sensor 23 and thereby selectively controls the first valve 35 and/or the second valve 19. In the illustrated embodiment, the proportional relay 25 uses air pressure from a source of air pressure 33 to control the first valve 35 and/or the second valve 19. Therefore, the proportional relay 25 controls the first valve 35 and/or the second valve 19, thereby controlling the pressure in the first outlet 15 and/or the second outlet 17, respectively. Furthermore, by controlling the pressure in the first outlet 15 and/or the second outlet 17, the apparatus 10 can control the amount of the liquid component being removed from the mass in the mass thickening assembly 40 as described in more detail below. Nevertheless, it is contemplated that any control system can be used to control and monitor the pressure in either the second piping section 26, the first outlet 15 and/or at the second outlet 17 to control the percentage of the liquid component removed from the mass in the mass thickening apparatus 40. The thickened mass can then be reinserted into another housing 42 for further thickening of the mass (at 7 in FIG. 1) or used in a final state as a thickened mass (at 9 in FIG. 1).

In the illustrated example, the mass thickening assembly 40 includes several features for cleaning the interior of the housing 42, the first side slotted filter screen 204 and the second side slotted filter screen 208. First, the scraper portion 84 of the center seal 76 includes a plurality of inlet scrapers 140 (see FIG. 12) extending upward from the side faces 106 of the scraper portion 84. The inlet scrapers 140 abut against the inside faces of the first side slotted filter screen 204 and the second side slotted filter screen 208 as the first side slotted filter screen 204 and the second side slotted filter screen 208 rotate past the inlet scrapers 140, thereby scraping the inside faces of the first side slotted filter screen 204 and the second side slotted filter screen 208 as they rotate past the inlet scrapers 140. Second, the scraper portion 84 of the center seal 76 includes a plurality of mass scrapers 142 (see FIG. 12) extending outward from the side faces 106 of the scraper portion 84. The mass scrapers 142 abut against the inside faces of the first side slotted filter screen 204 and the second side slotted filter screen 208 as the first side slotted filter screen 204 and the second side slotted filter screen 208 rotate past the inlet scrapers 140, thereby scraping the inside faces of the first side slotted filter screen 204 and the second side slotted filter screen 208 as they rotate past the scraper portion 84 of the center seal 76. Third, the scraper portion 84 of the center seal 76 includes a pair of wash nozzles 144 in the side faces 106 of the scraper portion 84. The scraper portion 84 includes a bore 146 through the scraper portion 84, with a washer fluid inlet 148 in the end face 108 of the scraper portion 84 (see FIG. 13). As illustrated in FIGS. 3 and 4, water entering the water supply 29 can also be directed to the washer fluid inlet 148 in the scraper portion 84 and then into the bore 146. The water is then ejected out of the bore 146 through the wash nozzles 144 in the side faces 106 of the scraper portion 84, thereby cleaning the first side slotted filter screen 204 and the second side slotted filter screen 208 as they rotate past the scraper portion 84. It is therefore contemplated that the nozzles 144 can wash and clean the first side slotted filter screen 204 and the second side slotted filter screen 208 during use of the apparatus 10 (i.e., while the mass is thickened). Finally, the entire housing 42 can be cleaned by injecting water or a cleaning fluid into the inner housing shell 48 and the outer housing shell 46 through the sanitary holes 60′, 60, respectively, as described above.

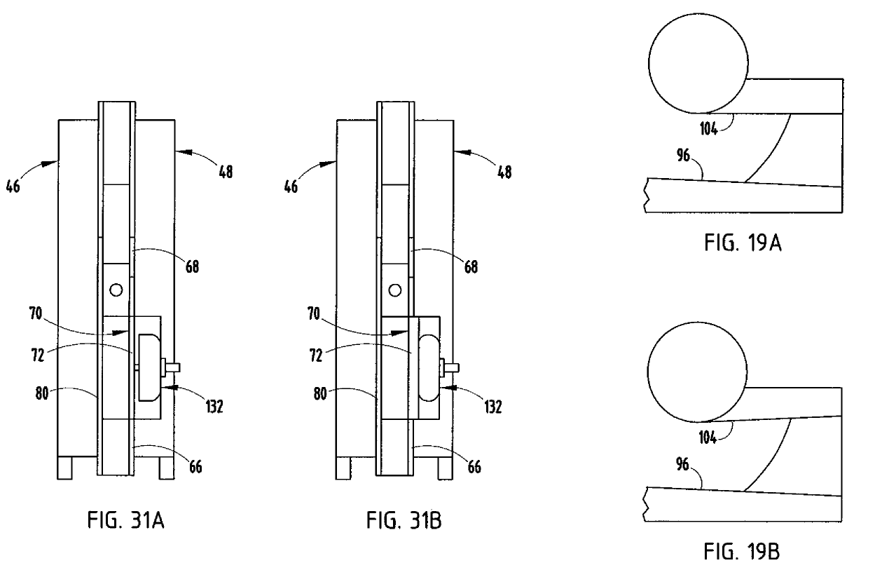

In the illustrated embodiment, the first outlet 15 of the housing 42 includes a top wall defined by the bottom face 104 of the scraper portion 84 of the center seal 76, a bottom wall defined by the angled top surface 96 of the outlet extension 92 of the center seal, a first side wall defined by the extension 80 of the outer housing shell 46 and a second side wall defined by the side wall 72. In the illustrated example, the first outlet 15 tapers outwardly because the top wall of the first outlet 15 is horizontal and the bottom wall tapers outwardly as described above such that the mass passes from a smaller area to a larger area as the mass passes through the first outlet 15 (see FIG. 19A). Furthermore, the side walls can either be parallel or have the side wall 72 taper outwardly as described above. Such an arrangement is illustrated in FIG. 19A. However, it is contemplated that the top wall, the bottom wall, the first side wall and/or the second side wall of the outlet can taper outwardly. For example, as illustrated in FIG. 19B, the bottom face 104 of the scraper portion 84 of the center seal 76 can taper outwardly, thereby providing the first outlet 15 with a top and bottom outwardly tapering wall.

The reference numeral 76a (FIG. 20) generally designates another embodiment of the present invention, having a second embodiment for the center seal. Since center seal 76a is similar to the previously described center seal 76, similar parts appearing in FIGS. 12-13 and FIG. 20, respectively, are represented by the same, corresponding reference number, except for the suffix “a” in the numerals of the latter. The center seal 76a includes an inwardly tapering inlet. The inlet of the housing and the center seal 76a tapers outwardly towards a rear 200 of the inlet such that a beginning 202 of the inlet is smaller than an end 204 of the inlet. A top of the first inlet plate, the second inlet plate, and the pair of grooves of the inlet extension will also taper outwardly towards the end 204 of the inlet. Therefore, in the second embodiment of the center seal 76a, the pressure of the mass entering the housing will decrease as the mass enters the inlet. The remainder of the center seal 76a and the housing can be identical to any of the center seals and housings described above.

The reference numeral 10b (FIG. 21) generally designates another embodiment of the present invention, having a second embodiment for the mass thickening apparatus. Since the apparatus 10b is similar to the previously described apparatus 10, similar parts appearing in FIGS. 1-19 and FIG. 21, respectively, are represented by the same, corresponding reference number, except for the suffix “b” in the numerals of the latter. In the second embodiment of the apparatus 10b, the housings 42b and everything therein is orientated upside-down, such that the inlet to the housing 42b is located below the outlet of the housing 42b and the mass will move upwardly through the housing 42b. However, the filtrate drain 62b will continue to be located at a bottom of the housing 42b, such that liquid will continue to be able to be drained out of the housing 42b. Furthermore, the sanitary holes 60b would continue to be located at a top of the housing 42b.

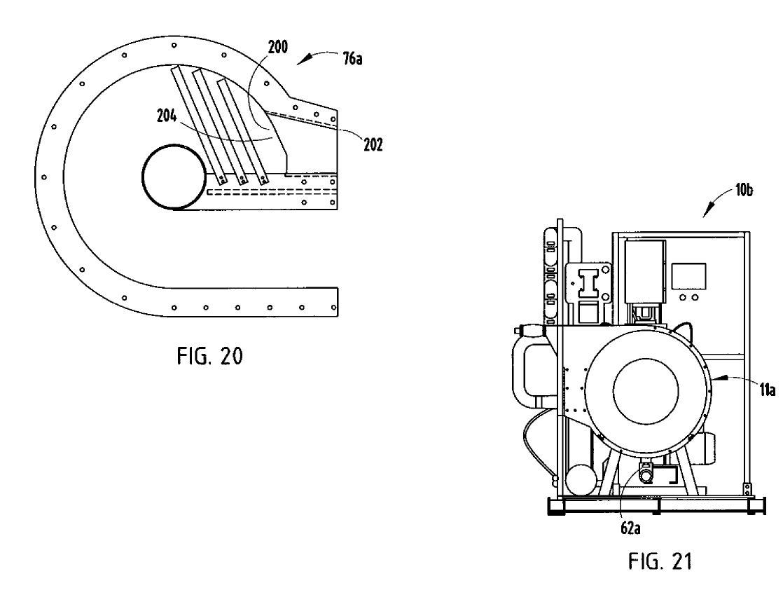

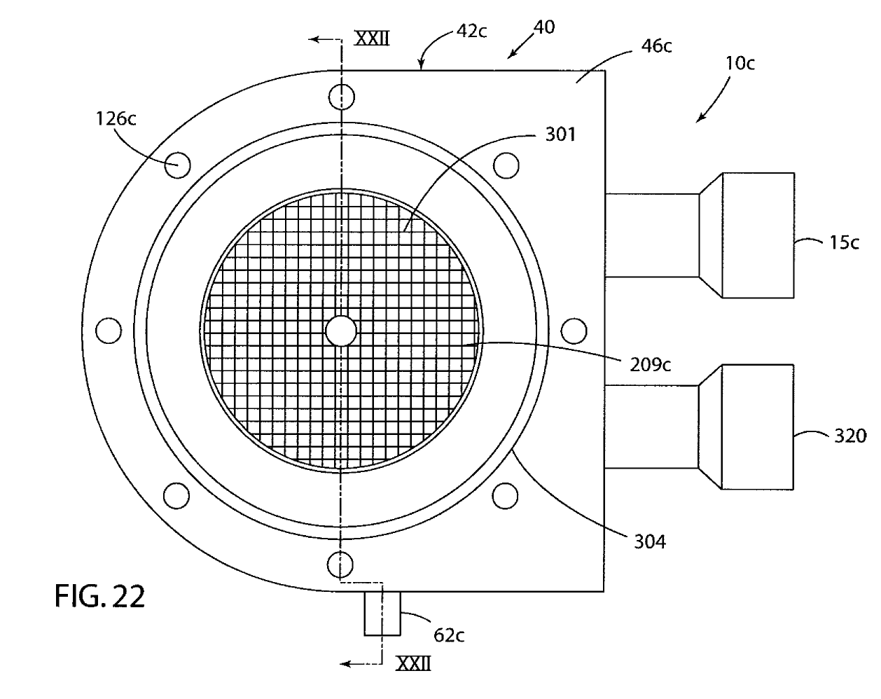

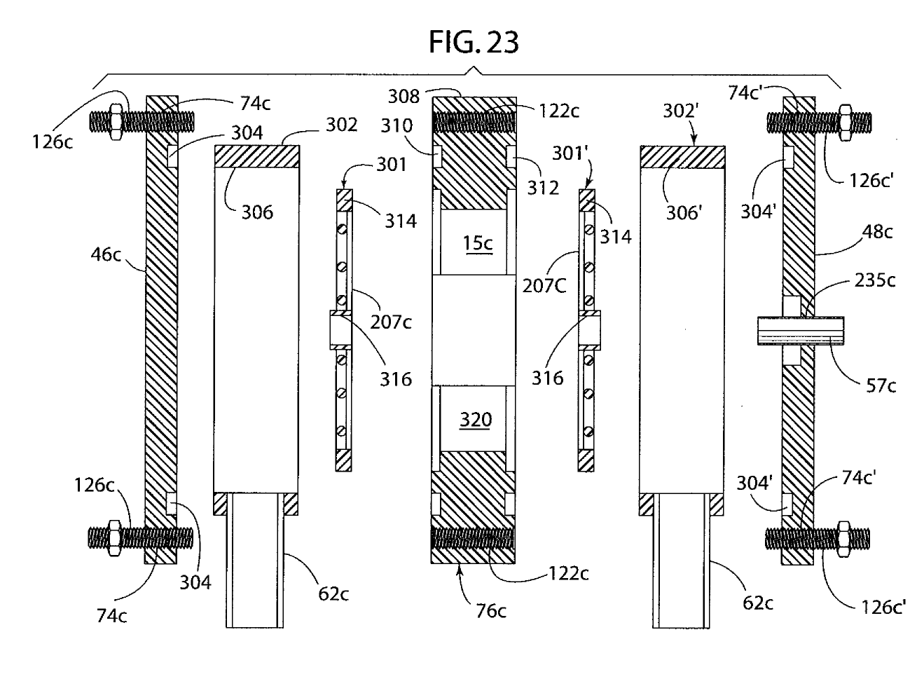

The reference number 10c (FIGS. 22-24) generally designates another embodiment of the present invention, having a third embodiment for the mass thickening apparatus. Since the apparatus 10c is similar to the previously described apparatus 10, similar parts appearing in FIGS. 1-19B and FIGS. 22-24, respectively, are represented by the same, corresponding reference number, except for the suffix “c” in the numerals of the latter.

As illustrated in FIGS. 22-24, the thickening assembly 40c comprises a housing 42c including an outer housing plate 46c and an inner housing plate 48c. The outer housing plate 46c is substantially a mirror image of the inner housing plate 48c. Located between the outer housing plate 46c and the inner housing plate 48c is an outer filtrate housing 302, an outer rotary screen assembly 301, a center seal 76c, an inner rotary screen assembly 301′ and an inner filtrate housing 302′. In the illustrated embodiment, the outer filtrate housing 302 is identical to the inner filtrate housing 302′ and the outer rotary screen assembly 301 is identical to the inner rotary screen assembly 301′ (although the outer rotary screen assembly 301 and the inner rotary screen assembly 301′ are in opposite orientations).

In the illustrated embodiment, the outer housing plate 46c of the housing 42c includes an inner circular groove 304 and a plurality of fastener openings 74c extending through the outer housing plate 46c and surrounding the inner circular groove 304. Likewise, the inner housing plate 48c includes an inner circular groove 304′ and a plurality of fastener openings 74c′ extending through the inner housing plate 48c and surrounding the inner circular groove 304′. The outer filtrate housing 302 is configured to be accepted in the inner circular groove 304 of the outer housing plate 46c and the inner filtrate housing 302′ is configured to be accepted in the inner circular groove 304′ of the inner housing plate 48c.

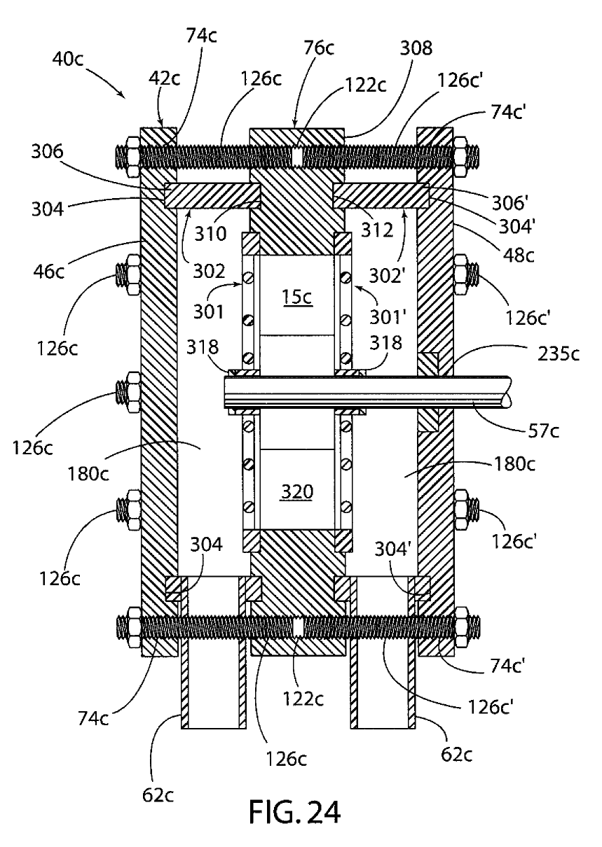

The illustrated outer filtrate housing 302 and inner filtrate housing 302′ each comprise a circular tube 306 and 306′ having a filtrate outlet 62c located at a bottom thereof. The filtrate outlet 62c comprises the second outlet 28 of the thickening assembly 40c. The center seal 76c comprises a body 308 having a first side groove 310 for accepting the circular tube 306 of the outer filtrate housing 302 therein and a second side groove 312 for accepting the circular tube 306 of the inner filtrate housing 302′ therein. The center seal 76c also includes a plurality of fastener openings 122c. As illustrated in FIG. 24, the outer housing plate 46c is connected to the center seal 76c by inserting a plurality of first fasteners 126c through the fastener openings 74c in the outer housing plate 46c and into the fastener openings 122c in the center seal 76c, thereby trapping the outer filtrate housing 302 therein. Likewise, the inner housing plate 48c is connected to the center seal 76c by inserting a plurality of second fasteners 126c′ through the fastener openings 74c′ in the inner housing plate 48c and into the fastener openings 122c in the center seal 76c, thereby trapping the inner filtrate housing 302′ therein. The inner filtrate housing 302′ and the outer rotary screen assembly 301 are adapted to rotate against the center seal 76c.

The illustrated inner rotary screen assembly 301′ and the outer rotary screen assembly 301 each include an outer rim 314, a face 207c having a plurality of slots 209c and an inner hub 316. It is contemplated that the filter screens could be made by connecting a plurality of wires to the outer rim 314 and the inner hub 316, thereby defining slots in the face 207c. Alternatively, it is contemplated that the rotary screens assemblies 301 and 301′ could be made by etching (for example, using water or another liquid) slots into an annular plate, thereby forming the outer rim 314, the face 207c having the plurality of slots and the inner hub 316. The rotary screen assemblies 301 and 301′ can also include a plurality of support bars extending between the outer rim 314 and the inner hub 316 for supporting a rear side of the face 207c having the plurality of slots therein. The slots allow for a high filtration area over the rotary screen assemblies 301 and 301′ compared to a perforated plate of the prior art, thereby providing a higher solid capture rate and easier cleaning. However, it is contemplated that the rotary screen assemblies 301 and 301′ of the present invention could include a perforated plate. It is contemplated that the rotary screen assemblies 301 and 301′ could have any diameter, including 24 and 36 inches. The slots preferably extend from a first point on the circumference of the filter screens to a second point on the circumference of the slotted filter screens (with a possible interruption if the slots cross the center of the slotted filter screens). The slots preferably have a triangular shape, with the larger end of the slots abutting against the mass as the mass moves through the thickening assembly 40c. In the illustrated embodiment, the inner housing plate 48c includes a drive shaft opening 235c centrally located therein. A drive shaft 57c connected to the motor (not shown) extends through the rotary screen assemblies 301 and 301′ and a center of the center seal 76c. Fixing members 318 are connected to the drive shaft 57c and maintain the rotary screen assemblies 301 and 301′ against the center seal 76c. The drive shaft 57c rotates the rotary screen assemblies 301 and 301′. It is further contemplated that the drive shaft 57c could have a longitudinal flange and the inner hubs 316 of the rotary screen assemblies 301 and 301′ could include key slots for accepting the longitudinal flange therein for assisting in rotating the rotary screen assemblies 301 and 301′.

As illustrated in FIGS. 22-24, the mass enters the thickening assembly 40c by entering a feed inlet 320 of the center seal 76c and exits through a thickened mass outlet 15c. A mass path extends between the feed inlet 320 and the thickened mass outlet 15c. While the feed inlet 320 and the thickened mass outlet 15c can be circular openings, it is contemplated that these openings could have any cross-sectional shape. Once the mass enters the center seal 76c through the feed inlet 320, the mass path forms a rectangular cross section. Preferably, the mass path at this point expands by having a top and bottom of the path taper outwardly along the direction of travel of the mass. Furthermore, once the mass enters through the feed inlet 320, sides of the mass path are covered by the faces 207c of the rotary screen assemblies 301 and 301′ as illustrated in FIG. 24. The mass path then forms a C-shaped cross-section, with the mass traveling towards the thickened mass outlet 15c as illustrated in FIG. 22. After the mass has passed by the rotary screen assemblies 301 and 301′, the mass path will thereafter become smaller. Preferably, the mass path at this point becomes smaller by having a top and bottom of the path taper inwardly along the direction of travel of the mass. It is contemplated that the housing 42c could also include sanitary holes and/or nozzles as described above for cleaning the thickening assembly 40c. While the mass is illustrated as traveling through the center seal from a lower area to an upper area, it is contemplated that the mass could travel downward, such that the feed inlet 320 is located above the thickened mass outlet 15c. Furthermore, while the rotary screen assemblies 301 and 301′ preferably rotate in the same direction as the direction of the path of travel of the mass, it is contemplated that the rotary screen assemblies 301 and 301′ could travel in a direction opposite to the direction of travel of the mass.

In the illustrated example, the rotary screen assemblies 301 and 301′ surround the center seal 76c and assist in removing the liquid portion from the mass. In use, the mass enters the thickening assembly 16 through the feed inlet 320 and is forced through the mass path. While the center seal 76c is fixed in position, the rotary screen assemblies 301 and 301′ will rotate as described above. The pressure of the mass in the piping will force the mass through the thickening assembly 40c towards the thickened mass outlet 15c of the thickening assembly 40c. However, as the mass is moving through thickening assembly 40c, the rotary screen assemblies 301 and 301′ on either side of the mass will remove a percentage of the liquid portion from the mass as described in U.S. Pat. No. 4,534,868, along with pressure caused by the first and/or second valves as discussed above. As the rotary screen assemblies 301 and 301′ and the first and/or second valves cause the liquid portion to be removed from the mass, the liquid travels down through a pair of areas 180c (see FIG. 24) between the rotary screen assemblies 301 and 301′ and each of the inner housing plate 48c and the outer housing plate 46c. The liquid then exits the housing 42 through the filtrate outlets 62c. Therefore, the liquid portion will flow through the rotary screen assemblies 301 and 301′ and down through the filtrate outlets 62c. The mass with the liquid portion removed will thereafter exit the thickening assembly 40c through the thickened mass outlet 15c. In the illustrated embodiment, the thickened mass outlet 15c comprises the first outlet 15c, which interacts with the first valve.

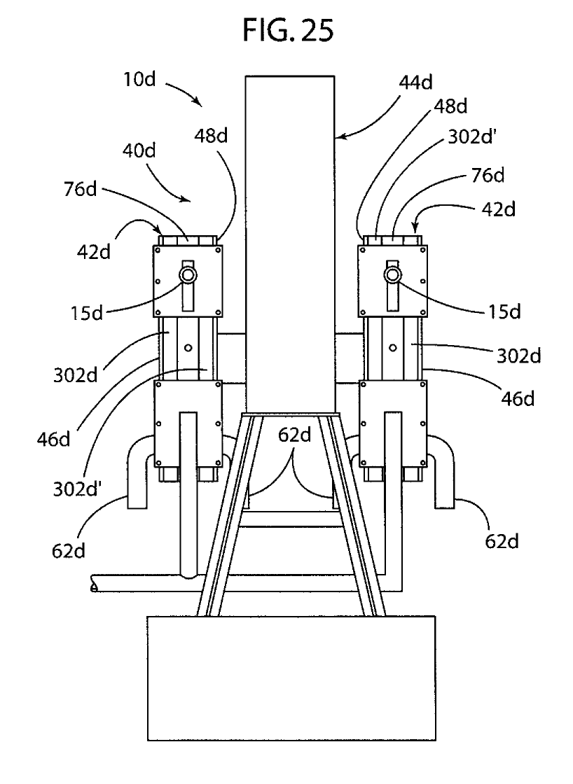

The reference number 10d (FIGS. 25-30) generally designates another embodiment of the present invention, having a third embodiment for the mass thickening apparatus. Since the apparatus 10d is similar to the previously described apparatus 10 and apparatus 10c, similar parts appearing in FIGS. 1-19B and 22-24, and FIGS. 25-30, respectively, are represented by the same, corresponding reference number, except for the suffix “d” in the numerals of the latter. In the third embodiment of the apparatus 10d, the mass thickening assembly 40d and everything therein is orientated upside-down (as in the second embodiment of the apparatus 10b), such that the inlet to the housing 42d is located below the first outlet 15d of the housing 42d and the mass will move upwardly through the housing 42d. However, the filtrate outlet 62d will continue to be located at a bottom of the housing 42d, such that liquid will continue to be able to be drained out of the housing 42d. Furthermore, the housing 42d will have a slightly different configuration as discussed below (although the mass thickening assembly 40d will continue to function the same as the mass thickening assembly 40). It is noted that FIG. 25 is a partial drawing of the apparatus 10d only showing the mass thickening assembly 40d and the motor assembly 44d, with the remaining elements (the platform, the system mass input, the polymer feeding and blending system, most of the piping, etc.) of the apparatus 10d being identical to the elements of the apparatus 10 as described above.

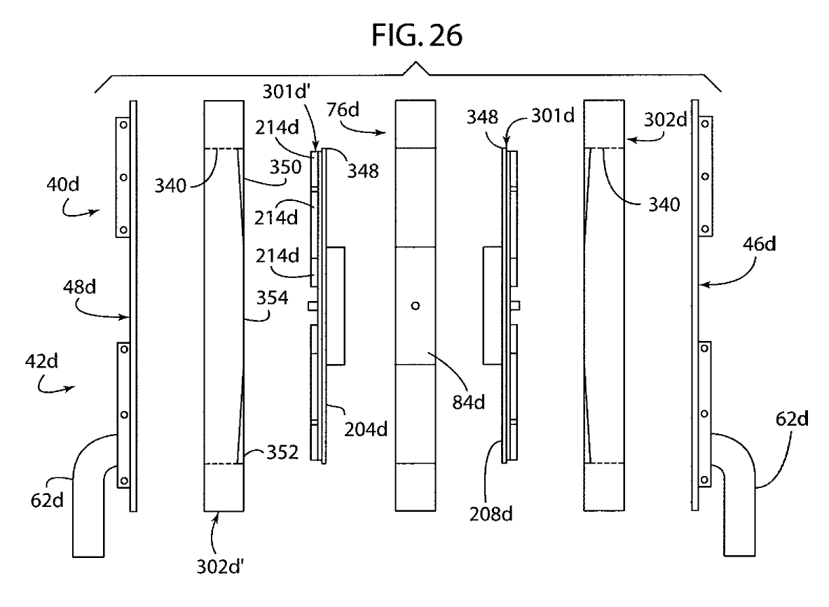

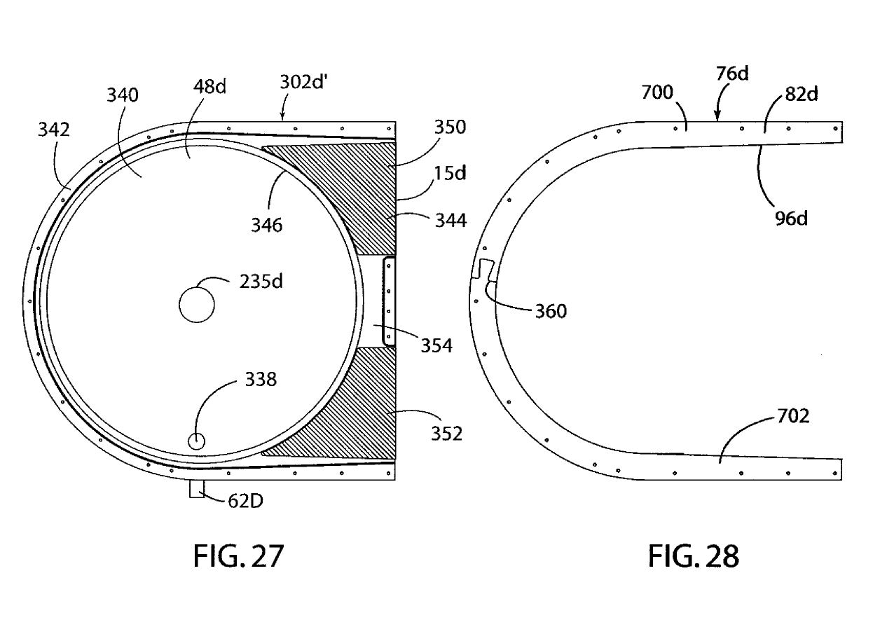

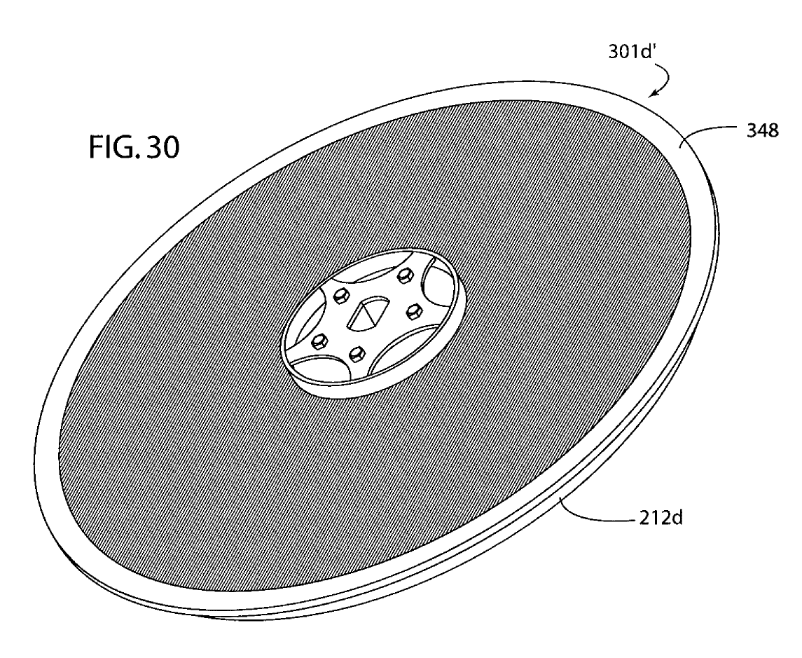

In the illustrated example, the mass thickening assembly 40d comprises a housing 42d including an outer housing plate 46d, an outer filtrate housing 302d, an outer rotary screen assembly 301d, a center seal 76d, an inner rotary screen assembly 301d′, an inner filtrate housing 302d′ and an inner housing plate 48d. The inner housing plate 48d and the inner filtrate housing 302d′ have a side view profile that is substantially C-shaped with a closed end as illustrated in FIG. 27. The inner housing plate 48d and the inner filtrate housing 302d′ have the same peripheral dimensions. The inner housing plate 48d includes a drive shaft opening 235d centrally located therein and an opening 338 connected to the filtrate drain 62d (which is therefore extending from a side of the housing 42d instead of from a bottom of the housing 42 as in the first embodiment of the assembly 40). The inner filtrate housing 302d′ includes a large central opening 340 thereby defining a C-shaped wall 342 and an end wall 344 in the inner filtrate housing 302d′. The inner filtrate housing 302d′ also includes an inner peripheral groove 346 adjacent the large central opening 340. The inner peripheral groove 346 is configured to accommodate an outer flange 348 of the inner rotary screen assembly 301d′ (see FIGS. 26 and 30). The inner filtrate housing 302d′ also includes an upwardly angled groove 350 and a downwardly angled groove 352 in the end wall 344 extending from a center 354 of the end wall 344. The upwardly angled groove 350 defines a side wall of the first outlet 15d of the housing 42d and the downwardly angled groove 352 defines a side wall of the inlet of the housing 42d. The inner rotary screen assembly 301d′, the inner filtrate housing 302d′ and the inner housing plate 48d are mirror images of the outer rotary screen assembly 301, the outer filtrate housing 302d and the outer housing plate 46d, respectively, except that the outer housing plate 46d does not include a drive shaft opening. Additionally, it is contemplated that the outer housing plate 46d could have a window (not shown) therein.

The illustrated center seal 76d (FIG. 28) is positioned between the outer filtrate housing 302d and the an inner filtrate housing 302d′ and defines an upper and lower boundary of the mass traveling through one of the housing 42d of the mass thickening assembly 40d. The center seal 76d also defines the inlet and the outlet for the mass through the housing 42d. The center seal 76d includes an outer C-shaped portion 82d and a scraper portion 84d. The outer C-shaped portion 82d includes top section 700 and a bottom section 702. The top section 700 of the outer C-shaped portion 82d includes an angled top surface 96d. The scraper portion 84d is located between the top section 700 and the bottom section 702 of the outer C-shaped portion 82d. The scraper portion 84d is substantially identical to the scraper portion 84 discussed above. The outer C-shaped portion 82d is preferably made in two parts for easy shipping and includes a puzzle piece type connection 360 for connecting the two parts together (see FIG. 28).

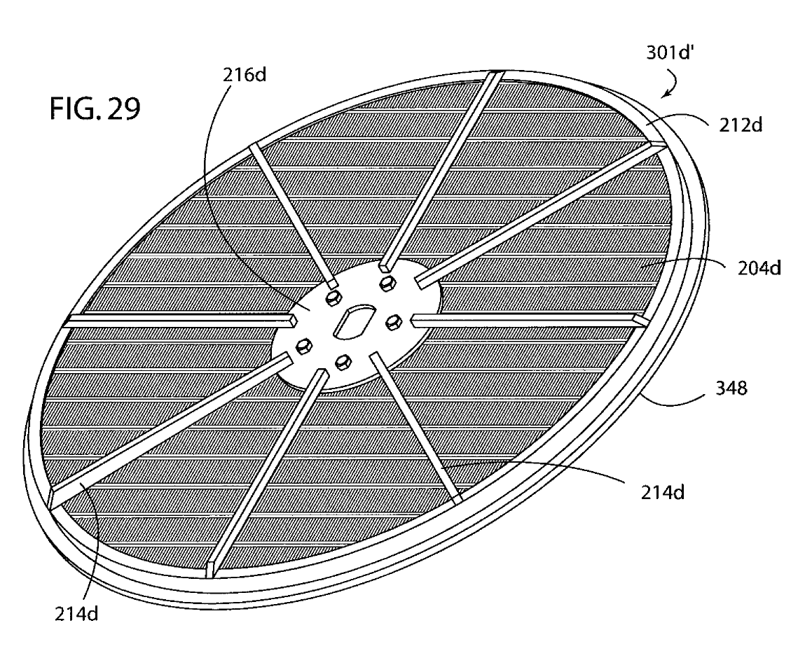

In the illustrated example, the outer rotary screen assembly 301d and the inner rotary screen assembly 301d′ (FIGS. 29 and 30) surround the center seal 76d and assists in removing the liquid portion from the mass. The illustrated outer rotary screen assembly 301d and the inner rotary screen assembly 301d′ each include an outer rim 212d, a plurality of spokes 214d and an inner rim 216d. The outer rim 212d and the inner rim 216d are substantially circular. The slotted screens 204d and 208d extend between the inner rim 216d and the outer rim 212d and are supported on a rear side by the plurality of spokes 214d. The plurality of spokes 214d also connects the outer rim 212d to the inner rim 216d. The screen assemblies 301d and 301d′, along with the first and/or second valves, assist in removing a percentage of liquid from the mass as discussed above.

In the illustrated example, any of the apparatuses 10-10d as discussed above can be converted from the mass thickening apparatus to an apparatus for extracting liquid from a humid mass (e.g., sludges and slurries), as those used or produced in the pulp and paper industry, waste water treatment plants, agricultural, food and beverage industries, etc. Such a liquid extraction system is disclosed in PCT Application No. PCT/US2005/028041 entitled ROTARY FAN PRESS, the entire contents of which are hereby incorporated herein by reference. In order to convert the apparatus to an apparatus for extracting liquid from a humid mass, it is preferred that the polymer feeding and blending system 18 as discussed above is activated (although this is not required). Furthermore, the second valve 19 is also deactivated to allow liquid to be removed from the mass without limitation. Finally, although the first valve 35 at the first outlet 15 could be used, it is preferred to remove the first valve 35 (a cone valve in the illustrated embodiment) and the stationary wall and replace the same with a movable side wall 72 in the open mouth 70 (of the first and second embodiments) to form a restriction plate at the first outlet 15. Such a configuration is illustrated in FIGS. 31A-31D. As shown in FIGS. 31A and 31B, the side wall 72 is located within the open mouth 70 defined by the bottom extending lip portion 66 and the nose portion 68 of the inner housing shell 48. The side wall 72 is hinged to a rear portion 130 of the open mouth 70 (see FIGS. 1 and 9-11). The side wall 72 has an air bellows 132 connected to an outer face thereof to rotate the side wall 72 about the hinge. In a fully closed position as shown in FIG. 31A, the side wall 72 is substantially parallel to the extension 80 of the outer housing shell 46. However, the air bellows 132 can be activated to rotate the side wall 72 about the hinge 134 to widen the exit of the liquid extraction press 11 as shown in FIG. 31B. Furthermore, it is contemplated that the bottom wall of the outlet could be horizontal and the top wall could taper outwardly by having the bottom face 104 of the scraper portion 84 of the center seal 76 taper outwardly. Moreover, it is contemplated that both side walls of the outlet can have the side wall 72 as discussed above (with the outer housing shell 46 including the open mouth 70 and a second side wall 72 therein) such that both of the side walls of the outlet can be selectively moved to taper outwardly. Additionally, it is contemplated that the side wall 72 could only comprise a portion of the side wall of the outlet, with a stationary side wall 72′ being located under or over the movable side wall 72 as illustrated in FIG. 31C. Furthermore, it is contemplated that both the side walls of the outlet could taper outwards in a direction from the top wall of the outlet to the bottom wall of the outlet as shown in FIG. 31D such that the distance between the side walls of the outlet is smaller at the top than the bottom of the side walls. For the third and fourth embodiments of the mass thickening apparatus, a C-shaped fixed wall with a fourth wall movable by a bellows (or with a pair of movable walls) (“a restrictor plate”) as discussed above can be substituted for the first valve to convert the mass thickening apparatus to a liquid extraction apparatus.

It is to be understood that variations and modifications can be made on the aforementioned structure without departing from the concepts of the present invention. For example, it is contemplated that the apparatus of the present invention could be modular in construction so additional units can be added for a single application or for future demands. Furthermore, it is contemplated that the pressure differential can be further altered by changing the flow rate of the mass into the thickening assembly (and keeping the valve positions the same or changing the positions of the valves). Moreover, it is contemplated that the center seal could include a C-shaped charging plate along an inner face of the center seal surround the path of the mass through the housing. The C-shaped charging plate can be configured to be connected to a volt power supply (e.g., at 48 volts) to provide a charge to the C-shaped charging plate. The charge on the C-shaped charging plate applies a positive charge to the mass forced through the liquid extraction assembly and a negative charge on the rotating screens, thereby drawing the mass towards the rotating screens to improve the extraction rate of the liquid from the mass. Moreover, it is contemplated that a pump would not be required to supply the mass to the apparatus under pressure. For example, the pressure could be provided by gravity or other force pushing the mass into the mass thickening assembly. Further, it is to be understood that such concepts are intended to be covered by the following claims unless these claims by their language expressly state otherwise.

I claim:

1. A mass thickening apparatus comprising:
a system mass input for accepting a mass having a solid component and a liquid component;
a pump operably connected to the system mass input for providing a pressure to the mass;
a thickening assembly adapted to receive the mass therein, the thickening assembly configured to selectively remove a percentage of the liquid component from the mass as the mass travels through the thickening assembly by controlling an amount of the liquid component that can be removed from the mass.

2. The mass thickening apparatus of claim 1, wherein:
the thickening assembly includes a first outlet for the mass with the percentage of the liquid component removed therefrom and a second outlet for the percentage of the liquid component.

3. The mass thickening apparatus of claim 2, further including:
a valve connected to the second outlet of the thickening assembly.

4. The mass thickening apparatus of claim 3, wherein:
the valve at least partially controls the amount of the liquid component that can be removed from the mass.

5. The mass thickening apparatus of claim 2, further including:
a valve connected to the first outlet of the thickening assembly.

6. The mass thickening apparatus of claim 3, wherein:
the valve at least partially controls the amount of the liquid component that can be removed from the mass.

7. The mass thickening apparatus of claim 2, further including:
valves connected to the first and second outlets of the thickening assembly.

8. The mass thickening apparatus of claim 7, wherein:
the valves at least partially control the amount of the liquid component that can be removed from the mass.

9. The mass thickening apparatus of claim 1, wherein:
the thickening assembly comprises:
a housing having an inlet and an outlet, the housing further including a path between the inlet and the outlet, the housing being configured to have the mass forced into the inlet to move the mass from the inlet to the outlet, the housing including at least one rotating screen adjacent the path, with each at least one rotating screen defining one wall of the path; and
pressure from mass forced into the input presses the mass against the rotating screen to thereby force the percentage of liquid in the mass to pass through the elongated slots of the at least one rotating screen.

10. The mass thickening apparatus of claim 9, wherein:
a valve connected to the outlet allows only the percentage of liquid to be removed from the mass.

11. The mass thickening apparatus of claim 9, wherein:
the at least one rotating screen includes a plurality of parallel elongated slots.

12. The mass thickening apparatus of claim 1, further including:
at least one pressure sensor for measuring the pressure of the mass entering the thickening apparatus and for measuring the pressure of the percentage of liquid removed from the thickening apparatus.

13. A method of thickening a mass having a solid component and a liquid component, the method comprising:
providing mass under pressure to a thickening assembly;
selectively removing a percentage of the liquid component from the mass with the thickening assembly by controlling an amount of the liquid component that can be removed from the mass; and
outputting the mass with the percentage of the liquid component removed therefrom from the thickening assembly.

14. The method of claim 13, further including:
operably connecting a pump to the system mass input for providing a pressure to the mass.

15. The method of claim 13, wherein:
the thickening assembly includes a first outlet for the mass with the percentage of the liquid component removed therefrom and a second outlet for the percentage of the liquid component.

16. The method of claim 15, further including:
connecting a valve to the second outlet of the thickening assembly.

17. The method of claim 16, wherein:
selectively removing a percentage of the liquid component from the mass comprises controlling the amount of the liquid component removed from the mass with the valve.

18. The method of claim 15, further including:
a valve connected to the first outlet of the thickening assembly.

19. The method of claim 18, wherein:
selectively removing a percentage of the liquid component from the mass comprises controlling the amount of the liquid component removed from the mass with the valve.

20. The method of claim 15, further including:
valves connected to the first and second outlets of the thickening assembly.

21. The method of claim 20, wherein:
selectively removing a percentage of the liquid component from the mass comprises controlling the amount of the liquid component removed from the mass with the valves.

22. The method of claim 13, wherein:
the thickening assembly comprises:
a housing having an inlet and an outlet, the housing further including a path between the inlet and the outlet, the housing being configured to have the mass forced into the inlet to move the mass from the inlet to the outlet, the housing including at least one rotating screen adjacent the path, with each at least one rotating screen defining one wall of the path; and
pressure from mass forced into the input presses the mass against the rotating screen to thereby force the percentage of liquid in the mass to pass through the elongated slots of the at least one rotating screen.

23. The method of claim 22, wherein:
a valve connected to the outlet allows only the percentage of liquid to be removed from the mass.

24. The method of claim 22, wherein:
the at least one rotating screen includes a plurality of parallel elongated slots.

25. The method of claim 13, further including:
measuring the pressure of the mass entering the thickening apparatus and the pressure of the percentage of liquid removed from the thickening apparatus with at least one pressure sensor.

26. A mass thickening and liquid extraction apparatus comprising:
a system mass input for accepting a mass having a solid component and a liquid component;
a pump operably connected to the system mass input for providing a pressure to the mass;
an assembly adapted to receive the mass therein, the assembly configured to remove a percentage of the liquid component from the mass as the mass travels through the assembly;
a valve selectively connectable to a first outlet of the assembly for controlling an amount of the liquid component that can be removed from the mass; and
a plate selectively connectable to a second outlet of the assembly for removing the liquid component from the mass.
